(19) United States
(12) Patent Application Publication
(10) Pub. No.: US 2026/0316058 A1
(43) Pub. Date: Oct. 15, 2026

(54) CATALYST FOR REFORMING METHANE-CARBON DIOXIDE MIXED GAS, METHOD OF MANUFACTURING THE SAME, AND METHOD OF REFORMING METHANE-CARBON DIOXIDE MIXED GAS USING SAME

(71) Applicant: HEESUNG CATALYSTS CORPORATION, Siheung-si (KR)

(72) Inventors: Dong Kun KANG, Siheung-si (KR); Ho-Dong KIM, Namyangju-si (KR); Jinwoo SONG, Incheon (KR)

(21) Appl. No.: 19/467,999

(22) Filed: Feb. 3, 2026

(30) Foreign Application Priority Data
Apr. 14, 2025 (KR) 10-2025-0048280

(51) Int. Cl. B01J 23/755; B01J 21/04; B01J 21/08; B01J 35/30; B01J 35/40; B01J 35/50; B01J 35/61; B01J 35/69; B01J 37/02; B01J 37/08; C01B 3/40

(52) U.S. Cl. CPC B01J 23/755; B01J 21/04; B01J 21/08; B01J 35/394; B01J 35/40; B01J 35/505; B01J 35/612; B01J 35/613; B01J 35/615; B01J 35/69; B01J 37/0221; B01J 37/0228; B01J 37/0236; B01J 37/0244; B01J 37/088; C01B 3/40; C01B 2203/0238; C01B 2203/1058; C01B 2203/1082; C01B 2203/1241

(57) ABSTRACT

Disclosed are a catalyst for reforming methane-carbon dioxide mixed gas, a method of manufacturing the same, and a method for reforming methane-carbon dioxide mixed gas using the same. The catalyst for reforming methane-carbon dioxide mixed gas includes an alumina carrier; a first shell disposed on the alumina carrier and including nickel metal; and a second shell disposed on the first shell and including silica, wherein a thickness of the second shell is greater than 1 μm and less than 500 μm.

### CROSS-REFERENCE TO RELATED APPLICATION

This application claims priority to and the benefit of Korean Patent Application No. 10-2025-0048280 filed with the Korean Intellectual Property Office on Apr. 14, 2025, the entire contents of which are incorporated herein by reference.

### BACKGROUND OF THE INVENTION

### (a) Field of the Invention

The present invention relates to a catalyst for reforming methane-carbon dioxide mixed gas, a method of manufacturing the same, and a method for reforming methane-carbon dioxide mixed gas using the same.

### (b) Description of the Related Art

In general, a reforming reaction of biogas typically containing methane and carbon dioxide (hereinafter, referred to as “methane-carbon dioxide mixed gas”) is performed by using a catalyst containing nickel as an active metal at high temperatures under high pressures.

However, during the reforming reaction of methane-carbon dioxide mixed gas, the nickel in the catalyst is gradually aggregated and sintered at the high temperatures into larger particles, which leads to disadvantages of progressively increasing a deactivation rate of the catalyst.

Furthermore, the reforming reaction of methane-carbon dioxide mixed gas is performed under a condition where steam is not abundant, which also leads to rapidly deactivating the catalyst due to coke deposition.

### SUMMARY OF THE INVENTION

An embodiment is to provide a catalyst for reforming a methane-carbon dioxide mixed gas having excellent resistance to coke deposition while suppressing a catalyst sintering phenomenon under high temperature conditions with insufficient steam.

An embodiment provides a catalyst for reforming methane-carbon dioxide mixed gas including an alumina carrier; a first shell disposed on the alumina carrier and including nickel metal; and a second shell disposed on the first shell and including silica, wherein a thickness of the second shell is greater than 1 μm and less than 500 μm.

Another embodiment provides a method for manufacturing a catalyst for reforming the methane-carbon dioxide mixed gas.

Another embodiment provides a method for reforming a methane-containing gas using the catalyst for reforming the methane-carbon dioxide mixed gas.

According to an embodiment, by using a catalyst having excellent resistance to coke deposition while suppressing a catalyst sintering phenomenon, catalyst deactivation in a methane-carbon dioxide mixed gas reforming reaction may be suppressed even under high-temperature conditions with insufficient steam.

### BRIEF DESCRIPTION OF THE DRAWINGS

FIG. 1 shows the EPMA analysis results for the final catalyst of Example 1.

FIG. 2 shows the EPMA analysis results for the final catalyst of Comparative Example 1.

FIG. 3 shows the results of SEM and EDS analysis at the same magnification of Example 1.

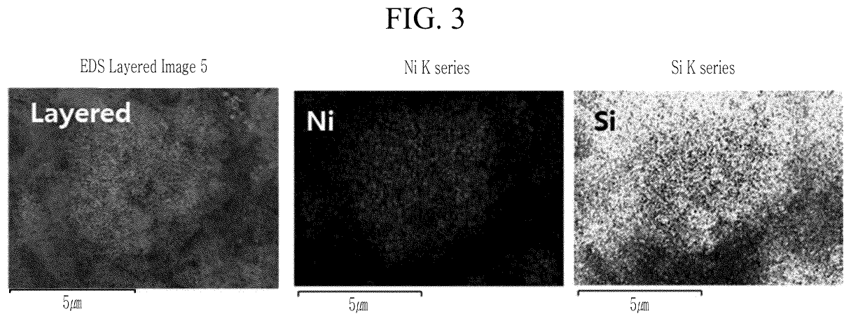

### DETAILED DESCRIPTION OF THE EMBODIMENTS

### Definition of Terms

Throughout this specification, when a part “includes” a certain element, this means that it may further include other elements rather than excluding other elements, unless specifically stated to the contrary.

As used throughout this specification, the term “~ing step” or “step of ~ing” does not mean “step for ~ing.”

As used herein, when a definition is not otherwise provided, the particle diameter may refer to an average particle diameter. For example, the particle diameter may be measured using transmission electron microscope (TEM) photographs, scanning electron microscope (SEM) photographs, or visual microscope photographs. By placing a spherical or molded catalyst into a resin, curing it, and then grinding it to exactly half, a cross-section of the catalyst may be secured, allowing the particle size to be measured.

Based on the above definitions, embodiments of the present invention will be described in detail. However, these embodiments are exemplary, the present disclosure is not limited thereto and the present disclosure is defined by the scope of claims.

### (Catalyst for Reforming Methane-Carbon Dioxide Mixed Gas)

An embodiment provides a catalyst for reforming methane-carbon dioxide mixed gas including an alumina carrier; a first shell disposed on the alumina carrier and including nickel metal; and a second shell disposed on the first shell and including silica, wherein a thickness of the second shell is greater than 1 μm and less than 500 μm.

An embodiment provides a catalyst for reforming methane-containing gas, which is applied to increase methane conversion rate and hydrogen production rate under high temperature conditions with insufficient steam.

The catalyst for reforming the methane-carbon dioxide mixed gas according to an embodiment of the present invention may exhibit excellent resistance to coke deposition while suppressing a catalyst sintering phenomenon. Accordingly, by using the catalyst of an embodiment, even when reforming a methane-carbon dioxide mixed gas under high-temperature conditions with insufficient steam, deactivation of the catalyst after the reforming reaction may be suppressed.

Hereinafter, a catalyst for reforming a methane-carbon dioxide mixed gas according to an embodiment is described in detail.

### Distribution of Components

Based on the alumina carrier, the nickel metal may be disposed on the alumina carrier (first shell), and the silica may be disposed on the nickel metal (second shell), forming a core-double shell structure. Additionally, the nickel metal may also be present in the internal pores of the alumina carrier.

The distribution of the components may be due to the manufacturing method.

For example, when a silica precursor is coated after a nickel precursor is supported on the alumina carrier, distribution of the components as described above may be possible, and when a nickel precursor is supported after the silica precursor is supported, the nickel metal may be uniformly distributed in the internal pores of the alumina carrier.

In contrast to the latter, the former has excellent resistance to coke deposition while suppressing the catalyst sintering phenomenon, and this is because most of the nickel metal is distributed mainly on the surface of the alumina carrier.

A ratio of the diameter of the alumina carrier: thickness of the silica shell may be 99:1 to 90:10, 99:1 to 93:7, or 98:2 to 95:5. Additionally, a thickness of the second shell may be greater than 1 μm and less than 500 μm, greater than or equal to 10 μm and less than or equal to 300 μm, or greater than or equal to 50 μm and less than or equal to 100 μm.

Within the above range, the catalyst activation effect by the nickel metal and suppression of the catalyst sintering phenomenon and coke deposition resistance by the silica shell that wraps the outer surface of the alumina carrier in a block shape may be harmonized.

### Pore Characteristics of Catalyst

A specific surface area of the catalyst may be 1 to 250 m²/g, or 15 to 210 m²/g; and a volume ratio of meso/macropores of the catalyst may be 0.1 to 1, or 0.3 to 0.8.

In the case of reforming catalysts, micropores and mesopores should be developed to increase the specific activity and reduce the movement restrictions of coke generated through the reaction, and macropores should also be developed to facilitate the movement of reactants and products.

In the case of a reforming catalyst with appropriately developed mesopores, a molecular selectivity within the pores is high, the resistance to deactivation is strong, and coke does not easily penetrate into the pores, and thus the inherent activity of the catalyst is maintained for a long time.

Within the above ranges, while increasing the generation of mesopores, maintaining an appropriate micro/mesopore volume ratio, internal diffusion of the supply gas is facilitated, so that the catalytic performance at low temperatures may also be increased.

### Amounts of Components

Based on the total amount of 100 wt % of the catalyst, the nickel metal may be included in an amount of 5 to 20 wt %, or 8 to 15 wt %; the silica may be included in an amount of 0.1 to 5 wt %, or 1 to 3 wt %; and the alumina carrier may be included in a balance amount.

Within the above range, the catalyst activation effect by the nickel metal and suppression of the catalyst sintering phenomenon and coke deposition resistance effect by the silica shell may be harmonized.

### Alumina Carrier

The alumina carrier may include any one of alpha-alumina, gamma-alumina, delta-alumina, eta-alumina, and theta-alumina, or a combination of two or more thereof. For example, alpha-theta-alumina, gamma-alumina, or theta-alumina may be used as the alumina carrier.

### (Method for Manufacturing Catalyst for Reforming Methane-Carbon Dioxide Mixed Gas)

An embodiment provides a method for manufacturing a catalyst for reforming methane-carbon dioxide mixed gas which includes: supporting a nickel precursor on an alumina carrier; performing heat treatment for a nickel precursor supported on the alumina carrier to obtain a first product; coating tetraalkyl orthosilicate as a silica precursor on the first product; and performing heat treatment and reducing the silica precursor coated on the first product to obtain a final catalyst.

The manufacturing method according to an embodiment may obtain the final catalyst of the above-described embodiment by including a process of coating a silica precursor after supporting a nickel precursor.

Hereinafter, descriptions overlapping with the above will be omitted, and a manufacturing method according to an embodiment will be described in detail.

### Alumina Carrier

The alumina carrier may be commercially available or manufactured directly. In the latter case, the alumina carrier of a specific crystal phase may be used after phase transformation by calcinating at 800 to 2,000° C. or 1,000 to 1,500° C. for 1 to 10 hours or 3 to 7 hours. The hybrid crystal phase according to the phase transition is as described above.

### Supporting and Performing Heat Treatment for Nickel Precursors

A first product may be obtained by performing heat treatment for the nickel precursor supported on the alumina carrier.

The nickel precursor may include nickel nitrate, nickel chloride, nickel acetate, nickel sulfate, a hydrate thereof, or a combination thereof.

Based on 100 parts by weight of the alumina carrier, the nickel precursor may be used in an amount of 40 to 70 parts by weight, or 50 to 60 parts by weight.

When supporting a nickel precursor on the alumina carrier, a spray drying method may be used.

Specifically, when supporting a nickel precursor on the alumina carrier, the method may include spraying an aqueous solution including the nickel precursor on the alumina carrier and then aging for 0.3 to 3 hours, or 0.5 to 2 hours; and drying the aged material at 50 to 200° C., or 100 to 150° C., for 5 to 20 hours, or 10 to 15 hours, and then performing heat treatment for the material at 500 to 1,500° C., or 700 to 1,000° C., for 1 to 15 hours, or 5 to 10 hours.

### Coating of Silica Precursor and Obtaining Final Product

The silica precursor may be tetraalkyl orthosilicate.

The tetraalkyl orthosilicate may become a shell that surrounds the surface of the first product in the heat treatment step described below. Meanwhile, if water-soluble colloidal silica is used instead of the tetraalkyl orthosilicate, the silica (second shell) may be distributed too thinly on the surface of the carrier, making it difficult to exhibit its effect. In addition, if fumed silica, which is an insoluble substance, is used instead of the tetraalkyl orthosilicate, the activity of the final catalyst obtained may be reduced.

Specifically, the silica precursor may be tetraethyl orthosilicate (TEOS), tetramethyl orthosilicate (TMOS), tetrapropyl orthosilicate (TPOS), tetrabutyl orthosilicate (TBOS), or a combination thereof.

For example, the silica precursor may be tetraethyl orthosilicate.

When a silica precursor is coated on the first product, the silica precursor may be coated in an amount of 1 to 20 parts by weight, or 3 to 15 parts by weight, based on 100 parts by weight of the alumina carrier.

Specifically, when a silica precursor is coated on the first product, spraying an aqueous solution including the silica precursor onto the first product may be included.

The final catalyst may be obtained through reduction after heat treatment in a state where a silica precursor is coated on the first product.

Herein, the method may include performing heat treatment for the first product in an air atmosphere of 300 to 800° C. or 450 to 650° C. for 1 to 10 hours or 3 to 5 hours to form a shell in which the first product is surrounded with a silica precursor; and increasing a temperature for the first product in which a shell is formed by surrounding the silica precursor in an air atmosphere to 500 to 1,000° C. or 500 to 700° C., then supplying hydrogen gas after nitrogen purging for 1 to 30 minutes or 3 to 10 minutes, thereby reducing the silica precursor of the shell to silica.

### (Method for Reforming Methane-Carbon Dioxide Mixed Gas)

Another embodiment provides a method for reforming a methane-carbon dioxide mixed gas using a catalyst according to the above-described embodiment. According to this, the deactivation of the catalyst in the methane-carbon dioxide mixed gas reforming reaction may be suppressed even under high temperature conditions with insufficient steam.

Hereinafter, descriptions overlapping with the above will be omitted, and a method for reforming methane-containing gas according to an embodiment will be described in detail.

When reforming the methane-carbon dioxide mixed gas, the catalyst is introduced into the reactor and the methane-carbon dioxide mixed gas is subjected to a gas phase reaction to produce hydrogen.

The methane-carbon dioxide mixed gas may be a gas in which methane/CO₂ is mixed in a volume ratio range of 1.0 to 1.5.

The reforming reaction of the methane-carbon dioxide mixed gas may be performed under conditions of a gas space velocity of 1,000 to 30,000 h⁻¹.

However, the above is only an example, and as the gas space velocity increases, the amount of hydrogen produced increases proportionally, so the optimal value may be arbitrarily adjusted according to the reactor volume and catalyst amount, and therefore, it is not limited to a specific value within the above range.

The reforming reaction of the methane-carbon dioxide mixed gas may be performed within a temperature range of 700° C. to 900° C.

If the reforming reaction temperature of the methane-carbon dioxide mixed gas is too low, the reforming reaction may insufficiently proceed, obtaining a very small amount of hydrogen. On the contrary, If the reforming reaction temperature of the methane-containing gas is too high, the active metal of the catalyst introduced into the reactor may exhibit agglomeration and sintering phenomena and side reactions such as coke formation, cracking reaction, and the like, which may cause a problem with catalyst durability.

The reactor is not particularly limited, but a fixed-bed catalytic reactor inside which a catalyst is filled may be used. Additionally, since the dehydrogenation reaction is an endothermic reaction, it is important that the reactor is always kept adiabatic. The reforming reaction process of the present invention may proceed while maintaining reaction conditions such as a reaction temperature, a pressure, and a gas space velocity within each appropriate range.

Hereinafter, the present invention will be described with reference to Examples, but the following Examples are intended to illustrate the present invention, and the scope of the present invention is not limited to these Examples.

### Example 1

### (1) Manufacturing of Alumina Carrier

A gamma alumina carrier (specific surface area: 210 m²/g, manufacturer: BASF, Germany) was calcinated at 1,100° C. for 5 hours to induce a phase transition. The phase-transited carrier was an alpha-theta hybrid alumina having theta alumina crystal phase: alpha alumina crystal phase in a ratio of 1:9 and had physical properties of a specific surface area of 19 m²/g and a pore size of 32 nm.

Subsequently, a nickel nitrate hydrate aqueous solution was sprayed to the alpha-theta hybrid alumina carrier and then, aged for about 1 hour to allow the nickel nitrate hydrate to be sufficiently impregnated into the alpha-theta hybrid alumina carrier. Herein, the nickel nitrate hydrate was used as a precursor for nickel metal.

Subsequently, the carrier was dried at 120° C. for 12 hours to completely remove moisture and then, heat-treated at 800° C. under an air atmosphere for 6 hours to convert the nickel nitrate hydrate supported on internal pores of the alpha-theta hybrid alumina carrier into nickel metal and fix it there. Herein, a ‘material including the alpha-theta hybrid alumina carrier and the nickel metal supported on the internal pores of the alumina carrier’ may be referred to as a ‘first product.’

Subsequently, the first product was sprayed with a tetraethyl orthosilicate (TEOS, CAS No. 78-10-4) aqueous solution and then, heat-treated at 550° C. under an air atmosphere for 4 hours to form a shell of surrounding the outer surface of the first product with TEOS

Herein, TEOS was used as a precursor for silica.

The first product with the shell formed was heated to 600° C. under the air atmosphere, purged with nitrogen for 5 minutes, and supplied with hydrogen gas to reduce TEOS of the shell to silica.

Accordingly, obtained was ‘a material including the alpha-theta hybrid alumina carrier; the nickel metal supported on the internal pores of the alumina carrier; and the silica shell enclosing the outer surface of the alumina carrier in a block-like manner’, which may be referred to as a ‘final product’ or a ‘final catalyst.’

### Examples 2 to 5

Final catalysts of Examples 2 to 5 were respectively manufactured in the same manner as in Example 1 except that the type of the carrier; and the amounts of the carrier and the silica precursor were respectively changed as shown in Table 1.

### Comparative Example 1

A final catalyst of Comparative Example 1 used the first product of Example 1 itself.

### Comparative Example 2

A final catalyst of Comparative Example 2 was obtained in the same manner as in Example 1 except that water-soluble colloid silica (Tradename: Ludox, Manufacturer: UniChem) was used instead of TEOS as the silica precursor.

### Comparative Example 3

A final catalyst of Comparative Example 3 was obtained in the same manner as in Example 1 except that fumed silica (Fumed SiO₂) was used instead of TEOS as the silica precursor.

### Comparative Example 4

A final catalyst of Comparative Example 4 was obtained in the same manner as in Example 1 except that the order of loading the nickel precursor and the silica precursor was reversed.

TABLE 1

| | Raw material | | | | | |
|---|---|---|---|---|---|---|
| | | | Nickel | Silica precursor | | |
| | Carrier | | precursor | | | Supporting |
| | Type | Amount | Amount | Type | Amount | order |
| Example 1 | a-t-Al₂O₃ | 88.5 g | 49.5 g | TEOS | 5.20 g | Post coating |
| Example 2 | a-t-Al₂O₃ | 89 g | 49.5 g | TEOS | 1.73 g | Post coating |
| Example 3 | a-t-Al₂O₃ | 87.0 g | 49.5 g | TEOS | 10.4 g | Post coating |
| Example 4 | r-Al₂O₃ | 88.5 g | 49.5 g | TEOS | 5.20 g | Post coating |
| Example 5 | t-Al₂O₃ | 88.5 g | 49.5 g | TEOS | 5.20 g | Post coating |
| Comparative | a-t-Al₂O₃ | 89.5 g | 49.5 g | — | — | Post coating |
| Example 1 | | | | | | |
| Comparative | a-t-Al₂O₃ | 88.5 g | 49.5 g | LUDOX | 3.75 g | Post coating |
| Example 2 | | | | | | |
| Comparative | a-t-Al₂O₃ | 88.5 g | 49.5 g | Fumed | 1.75 g | Post coating |
| Example 3 | | | | SiO₂ | | |
| Comparative | a-t-Al₂O₃ | 88.5 g | 49.5 g | TEOS | 5.20 g | Presupporting |
| Example 4 | | | | | | |

In Table 1, ‘a-t-Al₂O₃’ means alpha-theta-alumina, ‘r-Al₂O₃’ means gamma-alumina, and ‘t-Al₂O₃’ means theta-alumina. In addition, ‘post coating’ means coating a silica precursor after supporting a nickel precursor, and ‘presupporting’ means supporting a nickel precursor after supporting a silica precursor.

### Evaluation Example 1: Analysis of Structure and Properties of Final Catalyst

(1) Each of the final catalysts of Examples 1 to 5 and Comparative Examples 1 to 4 was subjected to EPMA analysis to evaluate structures and also, subjected to ICP analysis to evaluate component contents, and the results are shown in Table 2.

(2) Nitrogen adsorption isotherms were measured at-196° C. on a volume adsorption analyzer, Micromeritics 3Flex. Before measuring adsorption, all the samples were degassed at 350° C. in a degassing station. The Brunauer-Emmett-Teller (BET) equation was used to calculate the specific surface area from adsorption data obtained at P/P₀ between 0.05 and 0.2. The results are shown in Table 3.

(3) A volume ratio of meso/macropores was measured in a Micromeritics 3Flex volume adsorption analyzer and calculated from BJH desorption pore distribution data.

Herein, the macropores refer to pores with a diameter of 50 nm or more, while the mesopores refer to pores with a diameter of 2 to 50 nm. The results are shown in Table 3.

(5) A nickel distribution was obtained by analyzing a component distribution map on the cross-section of each of the catalysts through EPMA of the catalysts to analyze where nickel and silica were distributed. The results are shown in Table 3.

(6) A ratio of a diameter of the alumina carrier: a thickness of the silica shell was obtained by measuring actual thicknesses after checking the distribution through the EPMA analysis. The results are shown in Table 3.

TABLE 2

| | | Amount of components | |
|---|---|---|---|
| | Structure | nickel metal | silica |
| Example 1 | Ni in a-t-Al₂O₃@SiO₂ | 10 wt % | 1.5 wt % |
| Example 2 | Ni in a-t-Al₂O₃@SiO₂ | 10 wt % | 0.5 wt % |
| Example 3 | Ni in a-t-Al₂O₃@SiO₂ | 10 wt % | 3 wt % |
| Example 4 | Ni in r-Al₂O₃@SiO₂ | 10 wt % | 1.5 wt % |
| Example 5 | Ni in t-Al₂O₃@SiO₂ | 10 wt % | 1.5 wt % |
| Comparative | Ni in a-t-Al₂O₃ | 10 wt % | 0 wt % |
| Example 1 | | | |
| Comparative | Ni in a-t-Al₂O₃@SiO₂ | 10 wt % | 1.5 wt % |
| Example 2 | | | |
| Comparative | Ni in a-t-Al₂O₃@SiO₂ | 10 wt % | 1.5 wt % |
| Example 3 | | | |
| Comparative | Ni in SiO₂@a-t-Al₂O₃ | 10 wt % | 1.5 wt % |
| Example 4 | | | |

In Table 2, “Ni in a-t-Al₂O₃” indicates that nickel (Ni) is located in internal pores of alpha-theta-alumina (a-t-Al₂O₃), “Ni in a-t-Al₂O₃@SiO₂” indicates that a silica (SiO₂) shell is located on the “Ni in a-t-Al₂O₃”, and “Ni in SiO₂@a-t-Al₂O₃” indicates that silica (SiO₂) is located in the internal pores of the alpha-theta-alumina (a-t-Al₂O₃).

TABLE 3

| | Specific | Volume | | Thickness |
|---|---|---|---|---|
| | surface | ratio of | | of silica |
| | area | meso/macro | Nickel | shell |
| | (m²/g) | pores | distribution | (μm) |
| Example 1 | 19 | 0.699 | first shell + | 92 |
| | | | internal portion | |
| Example 2 | 17 | 0.537 | first shell + | 48 |
| | | | internal portion | |
| Example 3 | 23 | 0.781 | first shell + | 111 |
| | | | internal portion | |
| Example 4 | 210 | — | first shell + | 41 |
| | | | internal portion | |
| Example 5 | 98 | — | first shell + | 76 |
| | | | internal portion | |
| Comparative | 18 | 0.073 | internal portion | — |
| Example 1 | | | | |
| Comparative | 19 | 1.726 | first shell + | 17 |
| Example 2 | | | internal portion | |
| Comparative | 19 | 0.151 | first shell + | 32 |
| Example 3 | | | internal portion | |
| Comparative | 18 | 0.481 | internal portion | Uniform |
| Example 4 | | | | |

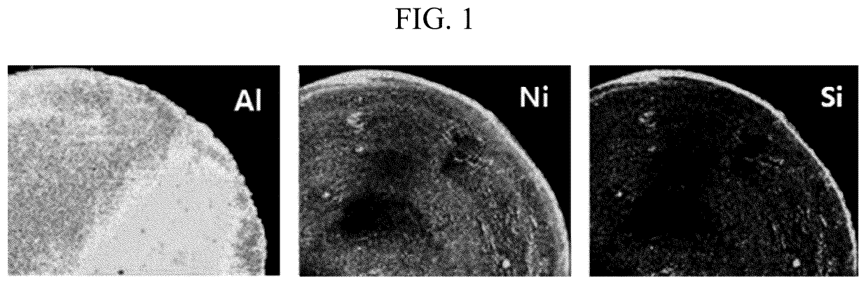

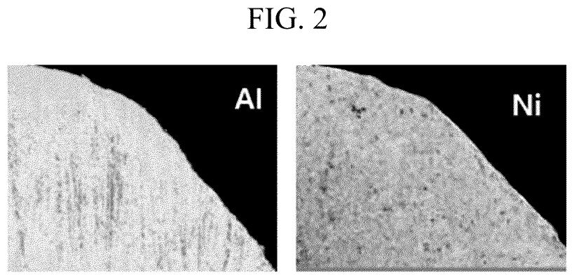

In particular, each of the final catalysts of Example 1 and Comparative Example 1 was subjected to EPMA analysis, and the results are shown in FIG. 1 (Example 1) and FIG. 2 (Comparative Example 1). FIGS. 1 and 2 respectively used a magnification of 50×.

Referring to FIGS. 1 and 2, the final catalyst of Comparative Example 1 was confirmed that nickel metal was evenly distributed inside the alumina carrier. On the contrary, the final catalyst of Example 1 was confirmed that the nickel metal and silica existed in a double shell structure and simultaneously, the nickel metal was also present inside the carrier.

Furthermore, FIG. 1 shows an SEM image of Example 1 and the corresponding EDS image at the same magnification as that of the SEM image. Referring to FIG. 1, it was clearly confirmed that the silica shell externally enclosing the alumina carrier in a block-like structure was present.

Accordingly, the final catalysts of Examples 2 to 5 were inferred to have the same structure of as that of Example 1 but confirmed to have a different silica content depending on an amount of the silica precursor.

On the other hand, the final catalyst of Comparative Example 4, in which the same silica precursor was used but in a different loading order, was confirmed to have a different structure.

In addition, Comparative Example 2, in which water-soluble colloid silica was used, was confirmed that the silica (second shell) was distributed too thinly on the carrier surface to exhibit its effect, and Comparative Example 3, in which fumed silica, an insoluble substance, was used, was confirmed to exhibit deterioration of catalyst activity. Effects of the catalysts will be described later.

### Evaluation Example 2: Performance Immediately after Preparation of Final Catalyst (Short-Term Activity Evaluation)

Immediately after preparing each of the final catalysts of Examples 1 to 5 and Comparative Examples 1 to 4, a reforming reaction of a mixed gas of methane/carbon dioxide (CO₂) in a volume ratio of 60:40 was performed at a reaction temperature of 650° C., 700° C., or 750° C. at a gas hourly space velocity of 4,500 h⁻¹, and the results are shown in Table 4.

(1) CH₄ conversion rates at different temperatures: The CH₄ conversion rates were calculated according to Equation 1 at each reaction temperature of 650° C., 700° C., or 750° C.

Conversion rate of methane (%)=(CH₄ (in)-CH₄ (out))/CH₄ (in)×100 [Equation 1]

(2) CO₂ conversion rate at 750° C.: At a reaction temperature of 750° C., the CO₂ conversion rate was calculated according to Equation 2.

Conversion rate of CO₂(%)=(CO₂ (in)−CO₂ (out))/CO₂ (in)×100 [Equation 2]

TABLE 4

| | CH₄ conversion rate | | | CO₂ conversion rate |
|---|---|---|---|---|
| | 650° C. | 700° C. | 750° C. | 750° C. |
| Example 1 | 88.6% | 93.5% | 95.8% | 47.8% |
| Example 2 | 88.3% | 93.1% | 95.5% | 45.5% |
| Example 3 | 87.3% | 92.1% | 94.8% | 46.5% |
| Example 4 | 81.5% | 83.8% | 87.4% | 21.2% |
| Example 5 | 83.1% | 85.9% | 91.8% | 22.9% |
| Comparative | 86.9% | 91.2% | 94.3% | 45.1% |
| Example 1 | | | | |
| Comparative | 87.8% | 92.6% | 95.2% | 36.7% |
| Example 2 | | | | |
| Comparative | 81.1% | 82.4% | 86.5% | 21.9% |
| Example 3 | | | | |
| Comparative | 82.9% | 86.1% | 89.9% | 23.2% |
| Example 4 | | | | |

### Evaluation Example 3: Performance of Final Catalyst after 500 Hours of Reaction (Durability Evaluation)

Each of the final catalysts of Examples 1 to 5 and Comparative Examples 1 to 4 was used for reforming a methane-carbon dioxide (CO₂) mixed gas in a volume ratio 60:40 at a reaction temperature of 750° C. and a gas hourly space velocity of 4,500 h⁻¹ for 500 hours, and the results are shown in Table 5.

(1) CH₄ conversion rate by hour: The CH₄ conversion rate was calculated according to Equation 1 of Evaluation Example 2, respectively, at the beginning of the reaction and after 500 hours.

(2) Coke deposition rate after 500 hours of reaction: The amount of coke deposited on the catalyst after 500 hours of reaction was measured.

(3) Catalyst deactivation rate: The catalyst deactivation rate was calculated according to the following equation (CH₄ conversion rate (500 hr)/CH₄ conversion rate (1 hr))×100).

TABLE 5

| | CH₄ | CH₄ | Coke | |
|---|---|---|---|---|
| | conversion | conversion | deposition | Catalyst |
| | rate (%) | rate (%) | rate after | deactivation |
| | (beginning) | (after 500 hr) | 500 hr | rate |
| | 750° C. | 750° C. | Reaction (%) | (%) |
| Example 1 | 95.8 | 95.5 | 1.11 | 0.31 |
| Example 2 | 95.5 | 95.1 | 1.32 | 0.47 |
| Example 3 | 94.8 | 94.5 | 0.89 | 0.30 |
| Example 4 | 87.4 | 79.9 | 5.8 | 8.58 |
| Example 5 | 91.8 | 87.1 | 4.2 | 5.12 |
| Comparative | 94.3 | 92.5 | 3.1 | 1.91 |
| Example 1 | | | | |
| Comparative | 94.5 | 93.1 | 1.38 | 1.48 |
| Example 2 | | | | |
| Comparative | 86.5 | 83.7 | 2.7 | 3.27 |
| Example 3 | | | | |
| Comparative | 89.9 | 86.9 | 2.8 | 3.33 |
| Example 4 | | | | |

Referring to Tables 4 and 5, compared to the final catalyst of Comparative Example 1, the final catalysts (second products) of Examples 1 to 5 exhibited that meso pores were not only more formed, but also micro/mesopores maintained an appropriate volume ratio, so that the supplied gas was more easily diffused into the internal pores, resultantly increasing catalyst performance at the low temperatures.

Furthermore, the final catalysts (second products) of Examples 1 to 3 were suppressed from agglomeration of nickel metal itself, leading to significantly reducing a deactivation speed of the catalysts and also, suppressed from coke formation of the nickel metal, thereby keeping the CH₄ conversion at a high rate during the reforming reaction.

Comparative Example 2, in which silica (second shell) was formed to be extremely thin on the carrier surface, was confirmed to exhibit deterioration of catalyst performance, and Comparative Example 3, in which fumed silica, an insoluble substance, was used, was confirmed to exhibit deterioration of catalyst activity.

Comparative Example 4, in which the loading order was switched, was confirmed that the final catalyst had a different structure, resultantly deteriorating activity of the catalyst.

In summary, the catalyst for reforming methane-carbon dioxide mixed gas according to an embodiment, represented by Examples 1 to 5 and particularly, Examples 1 to 3, was not only suppressed from the catalyst sintering phenomenon but also exhibited excellent resistance to coke deposition.

Accordingly, the catalyst of an embodiment, even after the reforming reaction of methane-carbon dioxide mixed gas, was suppressed from the deactivation.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A catalyst for reforming methane-carbon dioxide mixed gas, comprising
an alumina carrier;
a first shell disposed on the alumina carrier and including nickel metal; and
a second shell disposed on the first shell and including silica,
wherein a thickness of the second shell is greater than 1 μm and less than 500 μm.

2. The catalyst for reforming methane-carbon dioxide mixed gas of claim 1, wherein
the nickel metal is also present in internal pores of the alumina carrier.

3. The catalyst for reforming methane-carbon dioxide mixed gas of claim 1, wherein
a ratio of a diameter of the alumina carrier: a thickness of the second shell is 99:1 to 90:10.

4. The catalyst for reforming methane-carbon dioxide mixed gas of claim 1, wherein
a BET specific surface area of the catalyst is 1 to 250 m²/g, and
a volume ratio of mesopores/macropores of the catalyst is 0.1 to 1.

5. The catalyst for reforming methane-carbon dioxide mixed gas of claim 1, wherein
based on 100 wt % of a total amount of the catalyst,
the nickel metal is included in an amount of 5 to 20 wt %,
the silica is included in an amount of 0.1 to 5 wt %, and
the alumina carrier is included in a balance amount.

6. The catalyst for reforming methane-carbon dioxide mixed gas of claim 1, wherein
the alumina carrier is a hybrid alumina carrier including any one of alpha-alumina, gamma-alumina, delta-alumina, eta-alumina, and theta-alumina, or a combination of two or more thereof.

7. A method for manufacturing a catalyst for reforming methane-carbon dioxide mixed gas, comprising
supporting a nickel precursor on an alumina carrier;
performing heat treatment for a nickel precursor supported on the alumina carrier to obtain a first product;
coating tetraalkyl orthosilicate as a silica precursor on the first product; and
performing heat treatment and reducing the silica precursor coated on the first product to obtain a final catalyst.

8. The method of claim 7, wherein
the nickel precursor comprises nickel nitrate, nickel chloride, nickel acetate, nickel sulfate, a hydrate thereof, or a combination thereof.

9. The method of claim 7, wherein
the nickel precursor is used in an amount of 40 to 70 parts by weight based on 100 parts by weight of the alumina carrier.

10. The method of claim 7, wherein
when the nickel precursor is supported on the alumina carrier,
a spray drying method is used.

11. The method of claim 10, wherein
when the nickel precursor is supported on the alumina carrier,
the method includes
spraying an aqueous solution including the nickel precursor onto the alumina carrier and then aging for 0.3 to 3 hours; and
drying the aged material at 50 to 200° C. for 5 to 20 hours and then performing heat treatment at 500 to 1,500° C. for 1 to 15 hours.

12. The method of claim 7, wherein
the silica precursor is tetraethyl orthosilicate (TEOS), tetramethyl orthosilicate (TMOS), tetrapropyl orthosilicate (TPOS), tetrabutyl orthosilicate (TBOS), or a combination thereof.

13. The method of claim 7, wherein
when a silica precursor is coated on the first product,
the silica precursor is used in an amount of 1 to 20 parts by weight based on 100 parts by weight of the alumina carrier.

14. The method of claim 7, wherein
when a silica precursor is coated on the first product,
the method includes coating an aqueous solution including the silica precursor on the first product.

15. The method of claim 7, wherein
when the silica precursor is coated on the first product and then reduced after heat treatment,
the method includes
surrounding the first product with a silica precursor to form a shell by performing heat treatment for the first product in an air atmosphere at 300 to 800° C. for 1 to 10 hours; and
performing heat treatment for the first product in which a shell is formed by surrounding the silica precursor in an air atmosphere to reach 500 to 1,000° C., then supplying hydrogen gas after purging with nitrogen for 1 to 30 minutes to reduce the silica precursor of the shell to silica,

16. A method for reforming a methane-carbon dioxide mixed gas using the catalyst according to claim 1.
